(19) United States
(12) Patent Application Publication
(10) Pub. No.: US 2023/0061528 A1
(43) Pub. Date: Mar. 2, 2023

(54) METHOD, APPARATUS AND COMPUTER PROGRAM PRODUCT FOR AGGREGATING HAZARD POLYGONS

(71) Applicant: HERE GLOBAL B.V., Eindhoven (NL)

(72) Inventors: Leon STENNETH, Chicago, IL (US); Amarnath NAYAK, Mumbai (IN); Alex AVERBUCH, Buffalo Grove, IL (US)

(21) Appl. No.: 17/445,741

(22) Filed: Aug. 24, 2021

(51) Int. Cl. G01C 21/34; G01C 21/00

(52) U.S. Cl. CPC G01C 21/3461; G01C 21/3889; G01C 21/3841; G01C 21/3867; G01C 21/3415

(57) ABSTRACT

Embodiments described herein may provide a method for identifying hazard polygons in a geographic region from a plurality of sources and aggregating hazard polygons into a merged hazard polygon. Methods may include: receiving a first indication of a first hazard warning, where the first hazard warning includes a first hazard condition and a first hazard polygon in which the first hazard condition is estimated to be present; receiving a second indication of a second hazard warning, where the second hazard warning includes a second hazard condition and a second hazard polygon in which the second hazard condition is estimated to be present; generating, from the first hazard polygon and the second hazard polygon, a merged hazard polygon; and providing for at least one of navigational assistance or autonomous vehicle control based, at least in part, on the merged hazard polygon.

### TECHNOLOGICAL FIELD

An example embodiment of the present invention relates generally to providing local hazard warnings to an apparatus or device proximate a given location, and more particularly, to a method, apparatus and computer program product for identifying hazard polygons in a geographic region from a plurality of sources and aggregating hazard polygons into a merged hazard polygon.

### BACKGROUND

Various hazard identification systems exist to identify hazard conditions such as adverse weather conditions. Weather stations may be used to gather information regarding weather-related information at geographically dispersed locations, such that the weather information may be used for historical trend data, current weather reporting, and future weather prediction. Weather stations may include various sensors to gather weather-related information and report an abundance of weather attributes, such as temperature, humidity, barometric pressure, visibility, precipitation, wind speed, wind direction, etc. Weather stations traditionally have included stationary apparatus that included various types of specifically configured sensors to gather weather-related data. These traditional weather stations are conventionally located at airports, military bases, remote outposts, etc. However, these weather stations may not provide sufficient granularity in the identification of locations of hazard conditions.

One drawback of using location-based weather data from weather stations is that the weather data may only approximate the weather at a location in which a user is interested. The ubiquity of weather stations may result in an abundance of weather-related information, much of which may not be material to the desired weather information. More granular weather estimations may be provided by crowd-sourced sensors.

### BRIEF SUMMARY

A method, apparatus, and computer program product are therefore provided for providing local hazard warnings to an apparatus or device proximate a given location, and more particularly, to a method, apparatus and computer program product for identifying hazard polygons in a geographic region from a plurality of sources and aggregating hazard polygons into a merged hazard polygon. An apparatus may be provided including at least one processor and at least one non-transitory memory including computer program code instructions, the computer program code instructions may be configured to, when executed, cause the apparatus to at least: receive a first indication of a hazard warning, where the first hazard warning includes a first hazard condition and a first hazard polygon in which the first hazard condition is estimated to be present; receive a second indication of a second hazard warning, where the second hazard warning includes a second hazard condition and a second hazard polygon in which the second hazard condition is estimated to be present; generate, from the first hazard polygon and the second hazard polygon, a merged hazard polygon; and provide for at least one of navigational assistance or autonomous vehicle control based, at least in part, on the merged hazard polygon.

According to some embodiments, causing the apparatus to provide for at least one of navigational assistance or autonomous vehicle control based, at least in part, on the merged hazard polygon includes causing the apparatus to provide for at least one of navigational assistance or autonomous vehicle control based, at least in part, on the merged hazard polygon and a position of a vehicle for which the at least one of navigational assistance or autonomous vehicle control is provided entering a geographic area corresponding to the merged hazard polygon. Causing the apparatus of some embodiments to generate, from the first hazard polygon and the second hazard polygon, the merged hazard polygon includes causing the apparatus to generate from the first hazard polygon and the second hazard polygon the merged hazard polygon in response to the first hazard condition being within a predefined similarity of the second hazard condition.

According to some embodiments, causing the apparatus to generate, from the first hazard polygon and the second hazard polygon, the merged hazard polygon includes causing the apparatus to generate from the first hazard polygon and the second hazard polygon, the merged hazard polygon in response to the first hazard polygon at least partially overlapping the second hazard polygon. Causing the apparatus of some embodiments to generate, from the first hazard polygon and the second hazard polygon, the merged hazard polygon includes causing the apparatus to generate from the first hazard polygon and the second hazard polygon, the merged hazard polygon in response to the first hazard polygon being within a predefined distance of the second hazard polygon.

Causing the apparatus of some embodiments to provide for autonomous vehicle control includes causing the apparatus to cause a change of at least one vehicle setting of an autonomous vehicle in response to the autonomous vehicle entering a geographical area corresponding to the merged polygon. The first hazard polygon of some embodiments is generated based on probe data points within a geographic region corresponding to the first hazard polygon indicating a hazard condition at locations corresponding to the probe data points.

Embodiments provided herein include a computer program product including at least one non-transitory computer-readable storage medium having computer-executable program code instructions stored therein, the computer-executable program code instructions including program code instructions to: receive a first indication of a first hazard warning, where the first hazard warning includes a first hazard condition and a first hazard polygon in which the first hazard condition is estimated to be present; receive a second indication of a second hazard warning, where the second hazard warning includes a second hazard condition and a second hazard polygon in which the second hazard condition is estimated to be present; generate, from the first hazard polygon and the second hazard polygon, a merged hazard polygon; and provide for at least one of navigational assistance or autonomous vehicle control based, at least in part, on the merged hazard polygon.

According to some embodiments, the program code instructions to provide for at least one of navigational assistance or autonomous vehicle control based, at least in part, on the merged hazard polygon include program code instructions to provide for at least one of navigational assistance or autonomous vehicle control based, at least in part, on the merged hazard polygon and a position of a vehicle for which at least one of navigational assistance or autonomous vehicle control is provided entering a geographic area corresponding to the merged hazard polygon. The program code instruction to generate, from the first hazard polygon and the second hazard polygon, the merged hazard polygon include, in some embodiments, program code instructions to generate from the first hazard polygon and the second hazard polygon, the merged hazard polygon in response to the first hazard condition being within a predefined similarity of the second hazard condition.

According to some embodiments, the program code instructions to generate, from the first hazard polygon and the second hazard polygon, the merged hazard polygon include program code instructions to generate from the first hazard polygon and the second hazard polygon, the merged hazard polygon in response to the first hazard polygon at least partially overlapping the second hazard polygon. According to some embodiments, the program code instructions to generate, from the first hazard polygon and the second hazard polygon, the merged hazard polygon include program code instructions to generate from the first hazard polygon and the second hazard polygon, the merged hazard polygon in response to the first hazard polygon being within a predefined distance of the second hazard polygon.

According to some embodiments, the program code instructions to provide for autonomous vehicle control includes program code instructions to cause a change of at least one vehicle setting of an autonomous vehicle in response to the autonomous vehicle entering a geographical area corresponding to the merged polygon. The first hazard polygon of some embodiments is generated based on probe data points within a geographic region corresponding to the first hazard polygon indicating a hazard condition at locations corresponding to the probe data points.

Embodiments provided herein include a method including: receiving a first indication of a first hazard warning, where the first hazard warning includes a first hazard condition and a first hazard polygon in which the first hazard condition is estimated to be present; receiving a second indication of a second hazard warning, where the second hazard warning includes a second hazard condition and a second hazard polygon in which the second hazard condition is estimated to be present; generating, from the first hazard polygon and the second hazard polygon, a merged hazard polygon; and providing for at least one of navigational assistance or autonomous vehicle control based, at least in part, on the merged hazard polygon.

According to some embodiments, providing for at least one of navigational assistance or autonomous vehicle control based, at least in part, on the merged hazard polygon includes providing for at least one of navigational assistance or autonomous vehicle control based, at least in part, on the merged hazard polygon and a position of a vehicle for which the at least one of navigational assistance or autonomous vehicle control is provided entering a geographic area corresponding to the merged hazard polygon. Generating, from the first hazard polygon and the second hazard polygon, the merged hazard polygon in some embodiments includes generating from the first hazard polygon and the second hazard polygon the merged hazard polygon in response to the first hazard polygon at least partially overlapping the second hazard polygon.

Generating, from the first hazard polygon and the second hazard polygon, the merged hazard polygon in some embodiments includes generating from the first hazard polygon and the second hazard polygon the merged hazard polygon in response to the first hazard polygon being within a predefined distance of the second hazard polygon. According to some embodiments, providing for autonomous vehicle control includes causing a change of at least one vehicle setting of an autonomous vehicle in response to the autonomous vehicle entering a geographical area corresponding to the merged polygon.

Embodiments provided herein include an apparatus including: means for receiving a first indication of a first hazard warning, where the first hazard warning includes a first hazard condition and a first hazard polygon in which the first hazard condition is estimated to be present; means for receiving a second indication of a second hazard warning, where the second hazard warning includes a second hazard condition and a second hazard polygon in which the second hazard condition is estimated to be present; means for generating, from the first hazard polygon and the second hazard polygon, a merged hazard polygon; and means for providing for at least one of navigational assistance or autonomous vehicle control based, at least in part, on the merged hazard polygon.

According to some embodiments, the means for providing for at least one of navigational assistance or autonomous vehicle control based, at least in part, on the merged hazard polygon includes means for providing for at least one of navigational assistance or autonomous vehicle control based, at least in part, on the merged hazard polygon and a position of a vehicle for which the at least one of navigational assistance or autonomous vehicle control is provided entering a geographic area corresponding to the merged hazard polygon. The means for generating, from the first hazard polygon and the second hazard polygon, the merged hazard polygon in some embodiments includes means for generating from the first hazard polygon and the second hazard polygon the merged hazard polygon in response to the first hazard polygon at least partially overlapping the second hazard polygon.

The means for generating, from the first hazard polygon and the second hazard polygon, the merged hazard polygon in some embodiments includes means for generating from the first hazard polygon and the second hazard polygon the merged hazard polygon in response to the first hazard polygon being within a predefined distance of the second hazard polygon. According to some embodiments, the means for providing for autonomous vehicle control includes means for causing a change of at least one vehicle setting of an autonomous vehicle in response to the autonomous vehicle entering a geographical area corresponding to the merged polygon.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present invention in general terms, reference will hereinafter be made to the accompanying drawings which are not necessarily drawn to scale, and wherein:

FIG. 1 is a block diagram of an apparatus according to an example embodiment of the present disclosure;

FIG. 2 is a block diagram of a system for generating a local hazard warning from a plurality of information sources according to an example embodiment of the present disclosure;

FIG. 3 is a schematic of a mobile device in the form of a vehicle receiving hazard warning information from three different service providers according to an example embodiment of the present disclosure;

FIG. 4 illustrates a plurality of hazard polygons in a region according to an example embodiment of the present disclosure; and

FIG. 5 is a flowchart of a method for a merged hazard polygon according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

A method, apparatus and computer program product are provided in accordance with an example embodiment of the present invention for providing local hazard warnings to an apparatus or device proximate a given location, and more particularly, to a method, apparatus and computer program product for identifying hazard polygons in a geographic region from a plurality of sources and aggregating hazard polygons into a merged hazard polygon. In this regard, a user interface of a device, such a mobile device or a device affixed to a vehicle, such as to a dashboard or the like, may provide hazard warnings to a user, which may aid the user in navigation or driving in an instance in which the user is traveling by vehicle. A hazard warning, as described herein, includes a hazard condition and a hazard polygon. The hazard condition identifies the hazard that is present (e.g., rain, hail, snow, fog, etc.) while the hazard polygon identifies a boundary of the geographic area in which the hazard condition is estimated to exist. The display of a device such as a navigation system may provide information to a driver about hazards at or near their current location or hazards that are upcoming along their route or potential route. Further, such hazard warnings may be used by autonomous vehicle controls to provide some degree of control responsive to the hazardous condition identified provided the quality score satisfies a predetermined value.

As described herein, example embodiments of the claims may provide for a local hazard warning system. Local hazard warnings may be provided to a user via any available device, such as a mobile phone, tablet computer, fixed computer (e.g., desktop computer), or the like. Optionally, local hazard warnings may be provided to autonomous or semi-autonomous vehicle controls to aid the autonomous controls in providing safe travel along a road network. One example embodiment that will be described herein includes a user device of a user traveling in a vehicle. Such a device may be a mobile personal device that a user may use within a vehicle and outside of a vehicle environment, while other devices may include a vehicle navigation system. In some embodiments, the mobile personal device may double as a vehicle navigation system.

While the term “navigation system” is used herein to describe a device used to present map data, traffic data, etc., it is to be appreciated that such a navigation system can be used via a user interface without providing route guidance information. Route guidance is provided in response to a user entering a desired destination, and where a route between the origin or current location of a user and the destination is mapped and provided to the user. A navigation system may be used in the absence of a discrete destination to provide driver assistance and information.

Example embodiments described herein may provide a user device or navigation system where a portion of a user interface is used to present a local hazard warning to a user. A warning may include an alert to a user that adverse weather conditions are present proximate the user. The warning may be generated based on crowd-sourced weather-related information from vehicles, where the vehicles may be configured to report instances of adverse weather, including precipitation or foggy conditions. Precipitation may be in the form of rain, snow, sleet, hail, or ice, and the warning may communicate the severity of the condition in certain circumstances. The warning may be provided to a user of a device via a user interface, which may indicate that the warning corresponds to a current location of the user, or an anticipated future location of the user. According to example embodiments described herein, these hazard warnings may be generated in the form of hazard polygons defining a geographical region where the hazard is determined to exist. The formation of these hazard polygons of example embodiments is based on data and information from a plurality of sources aggregated locally and presented to a user or used by some form of autonomous vehicle control.

In example embodiments, a navigation system user interface may be provided for driver assistance for a user traveling along a network of roadways. Optionally, embodiments described herein may provide assistance for autonomous or semi-autonomous vehicle control. Autonomous vehicle control may include driverless vehicle capability where all vehicle functions are provided by software and hardware to safely drive the vehicle along a path identified by the vehicle. Semi-autonomous vehicle control may be any level of driver assistance from adaptive cruise control, to lane-keep assist, or the like.

Autonomous and semi-autonomous vehicles may use HD maps and an understanding of the context (e.g., traffic, weather, road construction, etc.) to help navigate and to control a vehicle along its path. In an instance in which a vehicle is subject to complete or partial autonomous control, hazard warnings associated with a hazard polygon defining a geographic area in which a hazard is determined to exist may inform the vehicle enabling appropriate actions to be taken. Those actions may include re-routing to avoid or partially avoid hazardous conditions, or to alter the operational state of the vehicle according to the hazard. Such operational state adjustments may include transitioning from two-wheel-drive to all-wheel-drive, changing the operational state of a traction control system from a dry-condition setting to a wet or snowy/icy condition setting, altering the transmission shift strategy or pattern to use lower gearing, or the like.

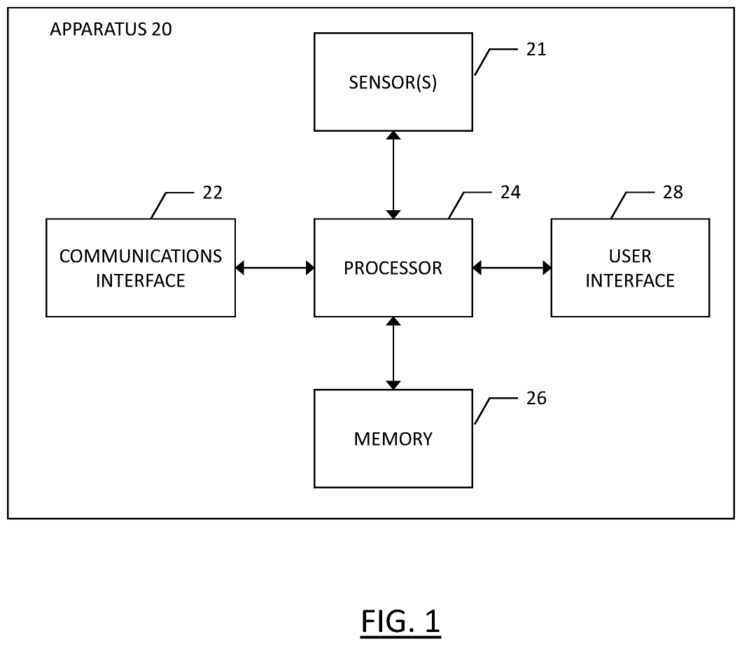

FIG. 1 is a schematic diagram of an example apparatus configured for performing any of the operations described herein. Apparatus 20 is an example embodiment that may be embodied by or associated with any of a variety of computing devices that include or are otherwise associated with a device configured for gathering weather related information and/or for presenting local hazard warnings to a user via a user interface. For example, the computing device may be a mobile terminal, such as a personal digital assistant (PDA), mobile telephone, smart phone, personal navigation device, smart watch, tablet computer, camera or any combination of the aforementioned and other types of voice and text communications systems. Optionally, the computing device may be a fixed computing device, such as a built-in vehicular navigation device, assisted driving device, or the like.

Optionally, the apparatus may be embodied by or associated with a plurality of computing devices that are in communication with or otherwise networked with one another such that the various functions performed by the apparatus may be divided between the plurality of computing devices that operate in collaboration with one another.

The apparatus 20 may be equipped with any number of sensors 21, such as a global positioning system (GPS), Light Distancing and Ranging (LiDAR) sensor, humidity sensor, image capture sensor, precipitation sensor, accelerometer, and/or gyroscope. Any of the sensors may be used to sense information regarding the movement, positioning, or orientation of the device and for determining a weather condition at the location of the device as described herein according to example embodiments. In some example embodiments, such sensors may be implemented in a vehicle or other remote apparatus, and the information detected may be transmitted to the apparatus 20, such as by near field communication (NFC) including, but not limited to, Bluetooth™ communication, or the like.

The apparatus 20 may include, be associated with, or may otherwise be in communication with a communication interface 22, processor 24, a memory device 26 and a user interface 28. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (for example, a computer readable storage medium) comprising gates configured to store data (for example, bits) that may be retrievable by a machine (for example, a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

The processor 24 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 24 may be configured to execute instructions stored in the memory device 26 or otherwise accessible to the processor. Alternatively or additionally, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (for example, the computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The apparatus 20 of an example embodiment may also include or otherwise be in communication with a user interface 28. The user interface may include a touch screen display, a speaker, physical buttons, and/or other input/output mechanisms. In an example embodiment, the processor 24 may comprise user interface circuitry configured to control at least some functions of one or more input/output mechanisms. The processor and/or user interface circuitry comprising the processor may be configured to control one or more functions of one or more input/output mechanisms through computer program instructions (for example, software and/or firmware) stored on a memory accessible to the processor (for example, memory device 24, and/or the like). In this regard, the apparatus 20 may interpret sensed data as certain weather conditions and establish location based on other sensor data, such as GPS data, for providing weather condition information for a specific location, for example.

The apparatus 20 of an example embodiment may also optionally include a communication interface 22 that may be any means such as a device or circuitry embodied in either hardware or a combination of hardware and software that is configured to receive and/or transmit data from/to other electronic devices in communication with the apparatus, such as by NFC, described above. Additionally or alternatively, the communication interface 22 may be configured to communicate over Global System for Mobile Communications (GSM), such as but not limited to Long Term Evolution (LTE). In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication may alternatively support vehicle to vehicle or vehicle to infrastructure wireless links.

According to certain embodiments, the apparatus 20 may support a mapping or navigation application so as to present maps or otherwise provide navigation or driver assistance. In order to support a mapping application, the computing device may include or otherwise be in communication with a geographic database, such as may be stored in memory 26. For example, the geographic database includes node data records, road segment or link data records, point of interest (POI) data records, and other data records. More, fewer or different data records can be provided. In one embodiment, the other data records include cartographic data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example. Furthermore, other positioning technology may be used, such as electronic horizon sensors, radar, LIDAR, ultrasonic and/or infrared sensors.

In example embodiments, a user device user interface and/or navigation system user interface may be provided to provide information or driver assistance to a user traveling along a network of roadways. Devices and systems may receive an indication of a current location of the user, and any location based hazard warnings such as hazard polygons associated with the current location of the device and user. While a service provider may be specifically configured to provide local hazard warnings to a user, such a service may be enhanced or improved through cooperation with other service providers that independently determine hazard conditions and hazard polygons. A user in their home may be able to watch television, visit a website on the internet, or listen to a radio station to understand weather patterns and potential hazard warnings at their relatively stationary location. However, when traveling, a user's location may be readily changing and their ability to continually monitor weather conditions or potential hazards may be limited. As such, a navigation system may be an ideal counterpart to a location-based hazard warning system as described herein. It is, however, appreciated that example embodiments described herein can be implemented outside of a navigation system, such as on a user device or other device that may not necessarily also provide navigation services.

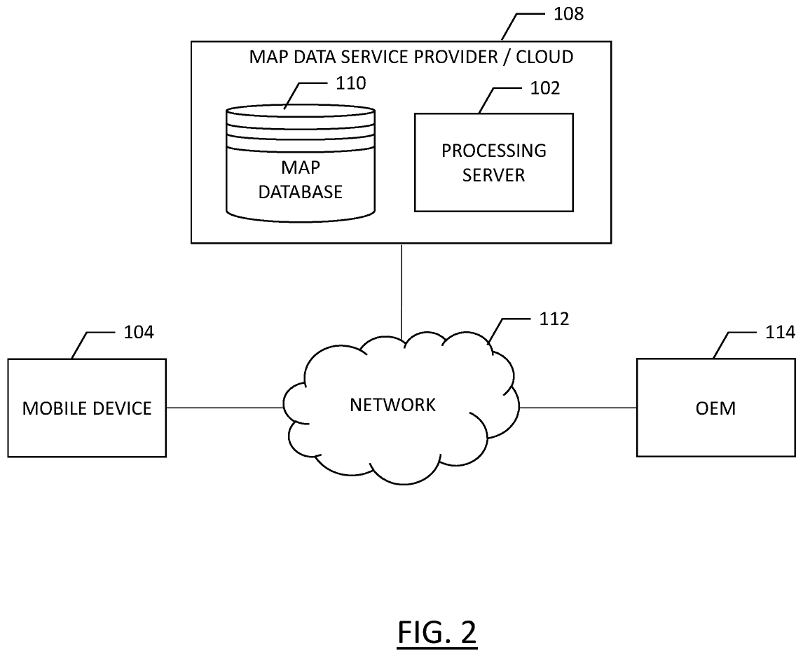

According to example embodiments, map service provider database may be used to provide driver assistance via a navigation system. FIG. 2 illustrates a communication diagram of an example embodiment of a system for implementing example embodiments described herein using a navigation system and a map data service provider. The illustrated embodiment of FIG. 2 includes a mobile device 104, which may be, for example, the apparatus 20 of FIG. 1, such as a mobile phone, an in-vehicle navigation system, or the like, an original equipment manufacturer (OEM) 114, and a map data service provider or cloud service 108. Each of the mobile device 104, OEM 114, and map data service provider 108 may be in communication with at least one of the other elements illustrated in FIG. 2 via a network 112, which may be any form of wireless or partially wireless network as will be described further below. Additional, different, or fewer components may be provided. For example, many mobile devices 104 may connect with the network 112. The map data service provider 108 may be cloud-based services and/or may operate via a hosting server that receives, processes, and provides data to other elements of the system.

The OEM 114 may include a server and a database configured to receive probe data from vehicles or devices corresponding to the OEM. For example, if the OEM is a brand of automobile, each of that manufacturer's automobiles (e.g., mobile device 104) may provide probe data to the OEM 114 for processing. That probe data may be encrypted with a proprietary encryption or encryption that is unique to the OEM. The OEM may be the manufacturer or service provider for a brand of vehicle or a device. For example, a mobile device carried by a user (e.g., driver or occupant) of a vehicle may be of a particular brand or service (e.g., mobile provider), where the OEM may correspond to the particular brand or service. The OEM may optionally include a service provider to which a subscriber subscribes, where the mobile device 114 may be such a subscriber. While depicted as an OEM 114 in FIG. 2, other entities may function in the same manner described herein with respect to the OEM. As such, the OEM 114 illustrated in FIG. 2 is not limited to original equipment manufacturers, but may be any entity participating as described herein with respect to the OEMs.

The map data service provider may include a map database 110 that may include node data, road segment data or link data, point of interest (POI) data, traffic data or the like. The map database 110 may also include cartographic data, routing data, and/or maneuvering data. According to some example embodiments, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities. Optionally, the map database 110 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 110 can include data about the POIs and their respective locations in the POI records. The map database 110 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 110 can include event data (e.g., traffic incidents, construction activities, scheduled events, unscheduled events, etc.) associated with the POI data records or other records of the map database 110.

The map database 110 may be maintained by a content provider e.g., the map data service provider and may be accessed, for example, by the content or service provider processing server 102. By way of example, the map data service provider can collect geographic data and dynamic data to generate and enhance the map database 110 and dynamic data such as traffic-related data or location-based hazard warning data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LIDAR, can be used to generate map geometries directly or through machine learning as described herein. However, the most ubiquitous form of data that may be available is vehicle data provided by vehicles, such as mobile device 104, as they travel the roads throughout a region. These vehicles or probes may be embodied by mobile device 104 and may provide data to the map data service provider in the form of traffic speed/congestion data, weather information, location, speed, direction, etc.

The map database 110 may be a master map database stored in a format that facilitates updates, maintenance, and development. For example, the master map database or data in the master map database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device 104, for example. The navigation-related functions can correspond to vehicle navigation, pedestrian navigation, or other types of navigation. While example embodiments described herein generally relate to vehicular travel along roads, example embodiments may be implemented for pedestrian travel along walkways, bicycle travel along bike paths, boat travel along maritime navigational routes, etc. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

The OEM 114 may be configured to access the map database 110 via the processing server 102 through, for example, a mapping application, such that the user equipment may provide navigational assistance to a user among other services provided through access to the map data service provider 108. According to some embodiments, the map data service provider 108 may function as the OEM, such as when the map data service provider is a service provider to OEMs to provide map services to vehicles from that OEM. In such an embodiment, map data service provider 108 may or may not be the recipient of vehicle probe data from the vehicles of that manufacturer. Similarly, the map data service provider 108 may provide services to mobile devices, such as a map services provider that may be implemented on a mobile device, such as in a mapping application. According to such an embodiment, the map data service provider 108 may function as the OEM as the map developer receives the probe data from the mobile devices of users as they travel along a road network.

As mentioned above, the map data service provider 108 map database 110 may be a master geographic database, but in alternate embodiments, a client side map database may represent a compiled navigation database that may be used in or with end user devices (e.g., mobile device 104) to provide navigation and/or map-related functions. For example, the map database 110 may be used with the mobile device 104 to provide an end user with navigation features. In such a case, the map database 110 can be downloaded or stored on the end user device which can access the map database 110 through a wireless or wired connection, such as via a processing server 102 and/or the network 112, for example.

In one embodiment, as noted above, the end user device or mobile device 104 can be embodied by the apparatus 20 of FIG. 1 and can include an Advanced Driver Assistance System (ADAS) which may include an infotainment in-vehicle system or an in-vehicle navigation system, and/or devices such as a personal navigation device (PND), a portable navigation device, a cellular telephone, a smart phone, a personal digital assistant (PDA), a watch, a camera, a computer, and/or other device that can perform navigation-related functions, such as digital routing and map display. An end user can use the mobile device 104 for navigation and map functions such as guidance and map display, for example, and for determination of useful driver assistance information, according to some example embodiments. An embodiment implemented as an ADAS may at least partially control autonomous or semi-autonomous features of a vehicle with the assistance of establishing the vehicle.

An ADAS may be used to improve the comfort, efficiency, safety, and overall satisfaction of driving. Examples of such advanced driver assistance systems include semi-autonomous driver assistance features such as adaptive headlight aiming, adaptive cruise control, lane departure warning and control, curve warning, speed limit notification, hazard warning, predictive cruise control, adaptive shift control, among others. Other examples of an ADAS may include provisions for fully autonomous control of a vehicle to drive the vehicle along a road network without requiring input from a driver. Some of these advanced driver assistance systems use a variety of sensor mechanisms in the vehicle to determine the current state of the vehicle and the current state of the roadway ahead of the vehicle. These sensor mechanisms may include radar, infrared, ultrasonic, and vision-oriented sensors such as image sensors and light distancing and ranging (LiDAR) sensors.

Driver assistance information may be communicated to a user via a display, such as a display of user interface 28 of apparatus 20 of FIG. 1. The display may be a display of a mobile phone, or a screen of an in-vehicle navigation system, for example. In the presentation of the driver assistance information to the user it is important that the information is communicated clearly and in an easily understood manner such that a user may quickly understand the information presented. As a user of a navigation system may be driving a vehicle, it is important that the navigation information including driver assistance information is quickly and easily understood, without requiring substantial user interaction should additional information be needed by the driver.

Example embodiments provided herein provide a method of providing local hazard warnings to an apparatus or device proximate a given location, and more particularly, to a method, apparatus and computer program product for identifying hazard polygons in a geographic region from a plurality of sources and aggregating hazard polygons. Mobile devices, such as mobile device 104 may be associated with a particular service provider (e.g., OEM 114 and/or map data service provider 108) where hazards are communicated from that particular service provider to the mobile device, and used by the mobile device to present a hazard condition (e.g., a hazard polygon) on a user interface and/or to inform vehicle automation regarding hazard conditions and polygons in which the hazard polygon is determined to exist. Conventionally, hazard conditions and their associated polygons depicting a boundary within which the hazard condition is determined to exist, are provided by individual service providers, whether they are map service providers or OEMs. Individually, these service providers may have limited knowledge of hazard conditions and where the corresponding hazard polygon boundaries should be. Individual service providers typically receive hazard condition reports only from mobile devices affiliated with the respective service provider (e.g., as a subscriber). This limits the hazard condition information available to a service provider. The limited information available to each service provider results in different hazard warnings including hazard conditions and hazard polygons.

In some circumstances, a mobile device 104 may receive hazard warning information including hazard polygons from multiple service providers. However, these hazard warnings and hazard polygons may be redundant in identifying the same hazard condition with some degree of overlap in their respective polygons. Such overlap can be detrimental to the user experience and can be detrimental to some automated vehicle systems with redundant and potentially conflicting hazard conditions and polygons. Hazard polygons from different sources may result in redundant warnings to a user and may include conflicting information, where one polygon ends but another continues, for example. Embodiments described herein employ hazard condition warnings and hazard polygons from multiple sources, and combine these hazard condition warnings and polygons to be a unified hazard condition warning and polygon for presentation to a user and/or for use by an automated vehicle system.

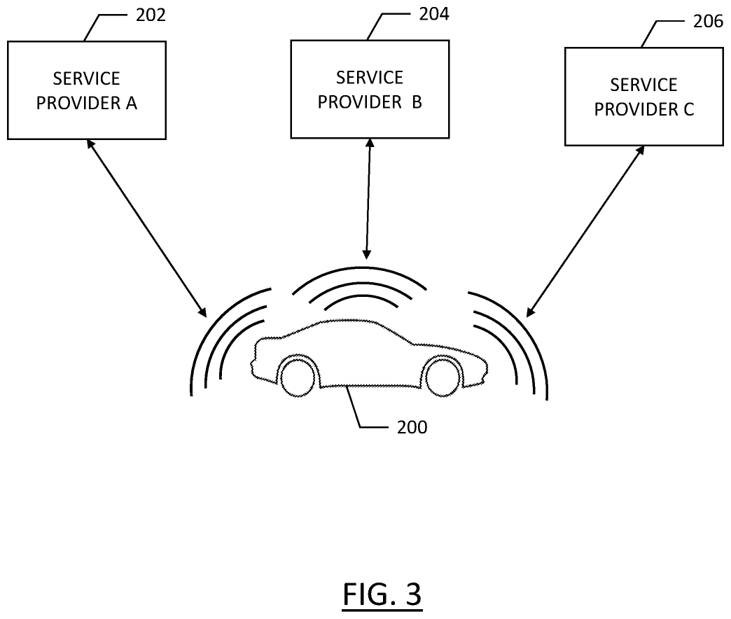

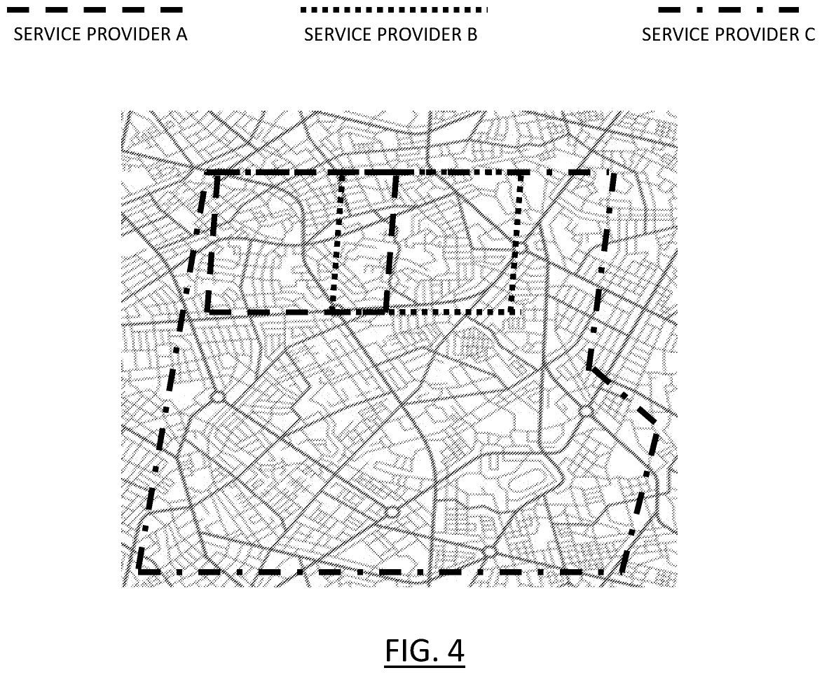

FIG. 3 illustrates an example embodiment of a vehicle 200 which may be or have integrated thereto the mobile device 104 of FIG. 2. The vehicle 200 may receive hazard warnings including hazard conditions and hazard polygons from multiple sources, such as the illustrated service provider A 202, service provider B 204, and service provider C 206. FIG. 4 illustrates an example embodiment of different hazard warnings from different service providers. As shown, service provider A includes a relatively small hazard polygon boundary shown by the dashed line. Service provider B includes a hazard polygon shown in dotted lines of similar size to that of service provider A, but covering a different area of the geographic region. Meanwhile, service provider C includes a hazard warning with hazard polygon shown in dash-dot-dash lines encompassing the other two hazard polygons.

The service provider A and service provider B hazard polygons are different due to different source data. As they are close together and share a significant portion of area, it would be beneficial to apply the two hazard polygons of service provider A and service provider B as a single polygon encompassing the area of both polygons. Further, the third hazard polygon of service provider C engulfs the hazard polygons of service provider A and service provider B. Embodiments described herein would use the hazard warnings of the three service providers and combine the hazard polygon boundary information to arrive at only the hazard polygon of service provider C as it encompasses the polygons of service providers A and B. This is under the presumption that the hazard conditions of the three hazard warnings are the same hazard condition. Embodiments may distinguish between hazard conditions and only combine hazard warnings when they are determined to pertain to hazard conditions of at least a predefined degree of similarity. For example, a first hazard warning having a hazard condition of moderate rain may not be combined with a second hazard warning having a hazard condition of hail given that hail can produce substantially more damage. However, a first hazard warning having a hazard condition of moderate rain may be combined with a second hazard warning having a hazard condition of light rain given the similarities of the hazard conditions.

One issue with multiple overlapping hazard polygons that are independent of one another sent to the same end user is that multiple hazard warnings will be communicated to the user potentially distracting the user when driving. For example, a warning for heavy rain may appear on a user interface, disappear, and reappear shortly thereafter as the user traverses hazard polygon borders. This could prove distracting. In the autonomous vehicle use case, a vehicle may transition back-and-forth from manual to automated/autonomous vehicle control as these hazard warnings are encountered.

Embodiments described herein “stitch” together the hazard polygons from different sources at the end-user device, such as mobile device 104. This results in a contiguous hazard polygon instead of several overlapping polygons. In geometry, the convex hull, convex envelope, or convex closure of a shape is the smallest convex set that contains it. The convex hull may be defined as the intersection of all convex sets containing a given subset of a Euclidean space, or equivalently as the set of all convex combinations of points in the subset. In the case of FIG. 4, a new polygon is developed that passes through the edge of hazard polygons from service provider A, service provider B, and service provider C resulting in a much bigger hazard polygon and engulfing the hazard polygons of service provider A and service provider B. In doing so, a user or mobile device would receive only one hazard warning in the region rather than three different warnings for the same hazard condition within a short amount of time.

The stitching or merging of hazard polygons described herein may be performed at the mobile device, such as at the user's mobile device 104 which may be a vehicle navigation system or mobile phone being used as a navigation device. Performing the merging of hazard polygons locally on a mobile device renders the hazard warning source agnostic while the mobile device can eliminate noise and respective warnings.

The merging of hazard polygons may be performed in the mobile device for all hazard polygons within a geographic region. In such an example, the mobile device will stitch together all of the polygons within the geographic area for a particular hazard condition regardless of whether the user will travel into the polygon or not. For example, all polygons that are currently active in the geographic area may be merged provided they have the same hazard condition or a hazard condition within a predefined degree of similarity. Further, the hazard polygons that are stitched together may be required to have at least some overlap. Optionally, the hazard polygons may be within a predefined threshold distance of one another to be considered part of the same hazard warning. Such a method of stitching together all hazard polygons within a geographic region related to the at least similar hazard condition can be time consuming.

According to another embodiment described herein, only hazard polygons relevant to a vehicle's path may be stitched together. In this manner, hazard polygons along a predefined route (provided the destination is known) may be stitched together as described herein. Optionally, hazard polygons may be stitched together as a user approaches one of the hazard polygons. This approach is more efficient and less time consuming, and is most efficient when used with a known route of a vehicle as it travels to a destination.

The stitching together of two or more hazard polygons may be triggered in response to a new hazard warning with a new hazard polygon being received by the mobile device. Optionally, the stitching together of two or more hazard polygons may be triggered based on periodic updates. This may be, for example, every thirty seconds, and may be configurable.

According to an example embodiment, within the hazard polygons, each vertex can be assigned a confidence value. For example, a vertex that is part of or within a hazard polygon for a hazard condition coming from more than one source, the confidence may be increased. If a vertex is within or part of a hazard polygon from all sources, the confidence may be very high that the hazard condition exists at that point. As the hazard warnings come from multiple sources, the source data for different hazard warnings is different. If the hazard warnings from two different sources include the same or similar hazard conditions and their respective hazard polygons overlap one another over an area, that overlap can be considered a confirmed hazard warning for that region based on two different datasets indicating the same hazard at the same location. If two hazard warnings indicate similar hazard conditions but their respective hazard polygons are separated by a short distance, it may be presumed that the hazard condition of the two hazard warnings also exists in the gap between the two hazard polygons.

Generally, a confidence of a hazard warning is established based on the source of the hazard warning. This confidence may vary based on the source data and the volume of source data. Further, different sources may be better equipped to provide higher confidence warnings based on their available data sources. If a hazard condition is established at a point or within a hazard polygon, a point outside of that point or polygon may also be experiencing the hazard condition; however, the greater the distance of that point from the hazard point or hazard polygon, the lower the confidence that a hazard condition exists at that point. The confidence provides a measure of how likely a hazard condition is present at a particular point. Confidence can be established from multiple data sources, such as if a point lies between three separate hazard warnings for a hazard condition, it is likely that the hazard condition exists at that point. Further, the closer the hazard warning polygons are to that point and the larger the number of hazard warnings in the vicinity, the greater the confidence that the hazard condition exists at that point. Confidence may further include a temporal factor, such as a decay over time as hazard conditions change.

The stitched together hazard polygons from a mobile device may be used, as described above, by a user such as through presentation of the hazard polygon on a map display user interface such that the user can take any necessary precautions. Optionally, an autonomous vehicle can employ the stitched together hazard polygons to determine one or more operational modes (e.g., traction control settings, two-wheel-drive vs. all-wheel-drive, etc.). These stitched together hazard polygons can be provided to other mobile devices and vehicles to better inform those mobile devices or vehicles. A map database, such as map database 110, may be updated with a stitched together hazard polygon for provision to one or more other mobile devices or vehicle.

Methods described herein establish a hazard and a location defined by a hazard polygon of any potential shape, and also identifies other hazards and locations potentially affected by the hazard condition within the same geographic area. Hazard polygons that overlap and/or are within a predefined threshold distance of one another may be combined based on at least a predefined similarity of their respective hazard conditions to form a combined hazard warning encompassing each hazard polygon relating to a particular hazard condition. Users in those locations (polygons) or users that may soon enter one of the polygons may be alerted or warned of the potential hazard condition. An algorithm has been established to facilitate the generation of a local hazard warning in a manner that may also indicate a quality of the local hazard warning such that action can be taken based on an assessment of the local hazard warning and the identified quality. While embodiments may provide information to a user regarding a local hazard condition, embodiments may optionally provide information to a controller of a vehicle that facilitates autonomous or semi-autonomous vehicle control, as noted above. In this manner, a warning may be provided to a vehicle and only to a user if configured as such, while the vehicle may take the necessary precautions based on the hazard warning and the associated quality of the local hazard warning information. While hazard warnings may be communicated only to a user/driver of a vehicle, or only to an autonomous vehicle, embodiments may provide the hazard warning to both the vehicle and the user to facilitate various degrees of autonomous vehicle control while also providing information to the driver to take the necessary precautions.

According to example embodiments described herein, the quality or reliability of hazardous condition data may be generated to identify the trustworthiness of the hazardous condition information. The quality score described herein is computed based on agreement of the presence of the hazard condition at particular locations within the geographic area. This may be performed by associating polygons created from vehicle sensor data against independently derived weather data on a point-by-point basis from radar, weather stations, and the like. Users and vehicles receiving the hazard condition data can understand the quality of the road hazard data and use that quality computation to determine how to use the hazard condition data. For example, if the computed quality is high with respect to a hazardous condition, the user and/or the vehicle may trust that a hazard exists within the reported area, and take the appropriate precautions. If the computed quality is low, such as when only one source indicates a hazardous condition at a location, then the user and/or vehicle can determine if any action is to be taken with respect to the identified hazard condition.

According to an example embodiment, potentially hazardous conditions can be detected by a device, such as a mobile device 104 traveling along a roadway. Example conditions may include fog or precipitation which may be detected by vehicles having capabilities as described above with respect to apparatus 20. Precipitation may be determined based on windshield wiper function, for example, while fog conditions may be identified based on activation of fog lights of a vehicle. Precipitation or fog may optionally be determined based on sensors of a vehicle, which may be detected in the form of noise from a LiDAR sensor or the like. However, detecting weather conditions from a single vehicle, or even a plurality of vehicles, may not always be reliable. For example, if a number of vehicles happen to have their fog lights on during a clear day or evening, fog could be assumed while there may not be fog present. Similarly, if one or more vehicles are traveling behind a vehicle, such as a truck, that has accumulated snow or water, the vehicles traveling behind the truck may each turn on their windshield wipers, while a weather condition does not actually exist. Hence, example embodiments of OEMs 114 and/or service providers such as map data service provider 108 aggregate crowd sourced information from a plurality of sources including vehicles traveling among a road network that are affiliated with the respective OEM or service provider.

A hazard warning algorithm of a service provider or OEM may process vehicle data to generate a polygon of the area affected by the local hazard, where each vertex of the polygon is represented as a longitude and latitude pair. A sensed condition may be reported by a vehicle traveling within a road network. The sensed condition may be windshield wipers operating above a predefined threshold (e.g., above intermittent or at a fast intermittent interval) or fog lights being activated. A pruning step may help avoid false-positives, such as using vehicle speed. The reporting vehicle speed may be required to be below a threshold speed for rain and/or fog, as high vehicle speeds suggest that weather is not impacting vehicle speed. An example may include where a vehicle traveling above 60 miles per hour is not traveling in fog. A different or the same threshold may be used for precipitation. Optionally, spatio-temporal hazard confidence may be established, where the spatio-temporal confidence is based on whether any other vehicles within a predefined distance and within a predefined amount of time of the reporting vehicle are experiencing similar conditions, and what proportion of vehicles in proximity to the reporting vehicle are experiencing the hazardous conditions. If vehicles in proximity, in space and/or time, to the reporting vehicle do not indicate a similar condition, then the spatio-temporal confidence may be low, and the hazard condition may be ignored.

Polygon construction may be performed by the service provider such as using a convex hull algorithm on individual clusters of data points. Polygon fitting may be performed at using, for example, a modified Douglas Peucker algorithm if the number of vertices exceeds a predefined amount. The output is a polygon indicating that a local hazard condition exists within the polygon as identified by the vehicles traveling in the region. Embodiments described herein go beyond this polygon generation to merge polygons from different sources at a mobile device to produce a cohesive aggregated hazard polygon.

Embodiments described herein optionally provide a quality measure that may influence how a local hazard warning is processed by a navigational system or autonomous vehicle control system. In this manner, a user may be presented with an alert to a local hazard warning area and a quality of the data supporting the local hazard warning area. The user may be presented with an option to take action with respect to the local hazard, or not. This decision may be influenced by the quality of the data, and a user may optionally take into consideration current context of the vehicle, such as if it is apparent that a hazard condition is likely (e.g., if storm clouds are visible). Similarly, an autonomous vehicle may use the quality of information with respect to a local hazard warning area to determine what actions may be taken responsive to the information. A threshold may be set, either manually by a user or by the autonomous vehicle control system, below which no action is taken in response to a low quality local hazard warning area, or above which action may be taken in response to a high quality local hazard warning area. Further, there may be multiple thresholds, where different actions are taken based on the quality of the local hazard warning area information. For example, a local hazard warning of moderate quality (e.g., between 30% and 70%) may result in some actions taken, while different, more substantial actions may be taken by an autonomous vehicle controller or a user in response to a higher quality of information pertaining to the local hazard warning.

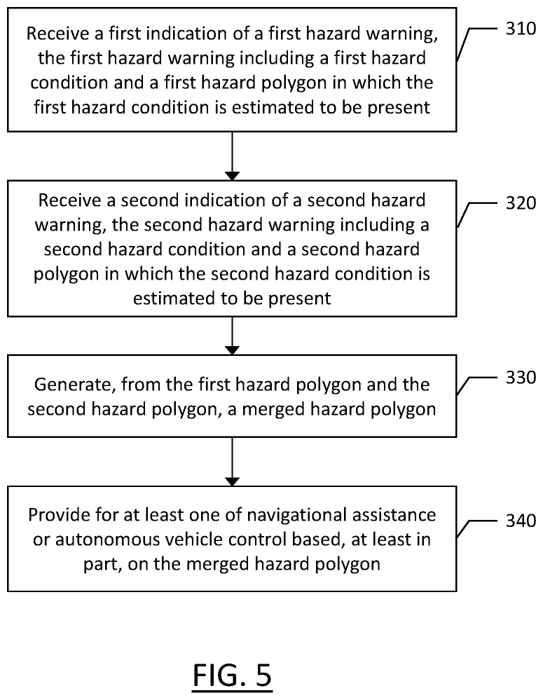

FIG. 5 is a flowchart illustrative of methods according to example embodiments of the present invention. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 of the apparatus 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 5 illustrates a method for providing local hazard warnings to an apparatus or device proximate a given location, and more particularly, to a method, apparatus and computer program product for identifying hazard polygons in a geographic region from a plurality of sources and aggregating hazard polygons. A first indication of a first hazard warning is received at 310, where the first hazard warning includes a first hazard condition and a first hazard polygon in which the first hazard condition is estimated to be present. A second indication of a second hazard warning is received at 320, where the second hazard warning includes a second hazard condition and a second hazard polygon in which the second hazard condition is estimated to be present. A merged hazard polygon is generated from the first hazard polygon and the second hazard polygon at 330. Navigational assistance and/or autonomous vehicle control is provided at 340 based, at least in part, on the merged hazard polygon.

In an example embodiment, an apparatus for performing the method of FIG. 5 above may comprise a processor (e.g., the processor 24) configured to perform some or each of the operations (310-340) described above. The processor may, for example, be configured to perform the operations (310-340) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 310-340 may comprise, for example, the processor 24 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one non-transitory memory including computer program code instructions, the computer program code instructions configured to, when executed, cause the apparatus to at least:
receive a first indication of a first hazard warning, wherein the first hazard warning comprises a first hazard condition and a first hazard polygon in which the first hazard condition is estimated to be present;
receive a second indication of a second hazard warning, wherein the second hazard warning comprises a second hazard condition and a second hazard polygon in which the second hazard condition is estimated to be present;
generate, from the first hazard polygon and the second hazard polygon, a merged hazard polygon; and
provide for at least one of navigational assistance or autonomous vehicle control based, at least in part, on the merged hazard polygon.

2. The apparatus of claim 1, wherein causing the apparatus to provide for at least one of navigational assistance or autonomous vehicle control based, at least in part, on the merged hazard polygon comprises causing the apparatus to provide for at least one of navigational assistance or autonomous vehicle control based, at least in part, on the merged hazard polygon and a position of a vehicle for which the at least one of navigational assistance or autonomous vehicle control is provided entering a geographic area corresponding to the merged hazard polygon.

3. The apparatus of claim 1, wherein causing the apparatus to generate, from the first hazard polygon and the second hazard polygon, the merged hazard polygon comprises causing the apparatus to generate from the first hazard polygon and the second hazard polygon, the merged hazard polygon in response to the first hazard condition being within a predefined similarity of the second hazard condition.

4. The apparatus of claim 1, wherein causing the apparatus to generate, from the first hazard polygon and the second hazard polygon, the merged hazard polygon comprises causing the apparatus to generate from the first hazard polygon and the second hazard polygon, the merged hazard polygon in response to the first hazard polygon at least partially overlapping the second hazard polygon.

5. The apparatus of claim 1, wherein causing the apparatus to generate, from the first hazard polygon and the second hazard polygon, the merged hazard polygon comprises causing the apparatus to generate from the first hazard polygon and the second hazard polygon, the merged hazard polygon in response to the first hazard polygon being within a predefined distance of the second hazard polygon.

6. The apparatus of claim 1, wherein causing the apparatus to provide for autonomous vehicle control comprises causing the apparatus to cause a change of at least one vehicle setting of an autonomous vehicle in response to the autonomous vehicle entering a geographical area corresponding to the merged polygon.

7. The apparatus of claim 1, wherein the first hazard polygon is generated based on probe data points within a geographic region corresponding to the first hazard polygon indicating a hazard condition at locations corresponding to the probe data points.

8. A computer program product comprising at least one non-transitory computer-readable storage medium having computer-executable program code instructions stored therein, the computer-executable program code instructions comprising program code instructions to:
receive a first indication of a first hazard warning, wherein the first hazard warning comprises a first hazard condition and a first hazard polygon in which the first hazard condition is estimated to be present;
receive a second indication of a second hazard warning, wherein the second hazard warning comprises a second hazard condition and a second hazard polygon in which the second hazard condition is estimated to be present;
generate, from the first hazard polygon and the second hazard polygon, a merged hazard polygon; and
provide for at least one of navigational assistance or autonomous vehicle control based, at least in part, on the merged hazard polygon.

9. The computer program product of claim 8, wherein the program code instructions to provide for at least one of navigational assistance or autonomous vehicle control based, at least in part, on the merged hazard polygon comprise program code instructions to provide for at least one of navigational assistance or autonomous vehicle control based, at least in part, on the merged hazard polygon and a position of a vehicle for which the at least one of navigational assistance or autonomous vehicle control is provided entering a geographic area corresponding to the merged hazard polygon.

10. The computer program product of claim 8, wherein the program code instruction to generate, from the first hazard polygon and the second hazard polygon, the merged hazard polygon comprise program code instructions to generate from the first hazard polygon and the second hazard polygon, the merged hazard polygon in response to the first hazard condition being within a predefined similarity of the second hazard condition.

11. The computer program product of claim 8, wherein the program code instructions to generate, from the first hazard polygon and the second hazard polygon, the merged hazard polygon comprise program code instructions to generate from the first hazard polygon and the second hazard polygon, the merged hazard polygon in response to the first hazard polygon at least partially overlapping the second hazard polygon.

12. The computer program product of claim 8, wherein the program code instructions to generate, from the first hazard polygon and the second hazard polygon, the merged hazard polygon comprise program code instructions to generate from the first hazard polygon and the second hazard polygon, the merged hazard polygon in response to the first hazard polygon being within a predefined distance of the second hazard polygon.

13. The computer program product of claim 8, wherein the program code instructions to provide for autonomous vehicle control comprise program code instructions to cause a change of at least one vehicle setting of an autonomous vehicle in response to the autonomous vehicle entering a geographical area corresponding to the merged polygon.

14. The computer program product of claim 8, wherein the first hazard polygon is generated based on probe data points within a geographic region corresponding to the first hazard polygon indicating a hazard condition at locations corresponding to the probe data points.

15. A method comprising:
receiving a first indication of a first hazard warning, wherein the first hazard warning comprises a first hazard condition and a first hazard polygon in which the first hazard condition is estimated to be present;
receiving a second indication of a second hazard warning, wherein the second hazard warning comprises a second hazard condition and a second hazard polygon in which the second hazard condition is estimated to be present;
generating, from the first hazard polygon and the second hazard polygon, a merged hazard polygon; and
providing for at least one of navigational assistance or autonomous vehicle control based, at least in part, on the merged hazard polygon.

16. The method of claim 15, wherein providing for at least one of navigational assistance or autonomous vehicle control based, at least in part, on the merged hazard polygon comprises providing for at least one of navigational assistance or autonomous vehicle control based, at least in part on the merged hazard polygon and a position of a vehicle for which the at least one of navigational assistance or autonomous vehicle is provided control entering a geographic area corresponding to the merged hazard polygon.

17. The method of claim 15, wherein generating, from the first hazard polygon and the second hazard polygon, the merged hazard polygon comprises generating from the first hazard polygon and the second hazard polygon, the merged hazard polygon in response to the first hazard condition being within a predefined similarity of the second hazard condition.

18. The method of claim 15, wherein generating, from the first hazard polygon and the second hazard polygon, the merged hazard polygon comprises generating from the first hazard polygon and the second hazard polygon, the merged hazard polygon in response to the first hazard polygon at least partially overlapping the second hazard polygon.

19. The method of claim 15, wherein generating, from the first hazard polygon and the second hazard polygon, a merged hazard polygon comprises generating from the first hazard polygon and the second hazard polygon, a merged hazard polygon in response to the first hazard polygon being within a predefined distance of the second hazard polygon.

20. The method of claim 15, wherein providing for autonomous vehicle control comprises causing a change of at least one vehicle setting of an autonomous vehicle in response to the autonomous vehicle entering a geographical area corresponding to the merged polygon.
